(19) United States
(12) Patent Application Publication
(10) Pub. No.: US 2013/0010830 A1
(43) Pub. Date: Jan. 10, 2013

(54) RADIO COMMUNICATION APPARATUS AND RADIO COMMUNICATION METHOD

(75) Inventors: Toshinori Hori, Tokyo (JP); Yukimasa Nagai, Tokyo (JP)

(73) Assignee: Mitsubishi Electric Corporation, Tokyo (JP)

(21) Appl. No.: 13/520,896

(22) PCT Filed: Jan. 6, 2010
(86) PCT No.: PCT/JP10/50055

§ 371 Date: Jul. 6, 2012

(51) Int. Cl. H04B 1/713

(52) U.S. Cl. 375/133; 375/E01.033

(57) ABSTRACT

A BT apparatus unit configured to perform Bluetooth (registered trademark) communication, a WLAN apparatus unit configured to perform WLAN communication, and an information managing unit configured to acquire a WLAN communication frequency band, which is a frequency band used for the WLAN communication, from the WLAN apparatus unit, determine an unusable frequency band based on the acquired WLAN communication frequency band, and notify the BT apparatus unit of the determined unusable frequency band. The BT apparatus unit performs frequency hopping using a frequency band excluding the unusable frequency band.

### FIELD

The present invention relates to a field of a digital radio communication system and relates to a radio communication apparatus mounted with a plurality of radio devices of different radio systems that use the same frequency band.

### BACKGROUND

An unlicensed user can use a radio apparatus in a 2.4 GHz band, which is called ISM (Industry Science Medical) band, as long as criteria defined by the Radio Law are satisfied. Therefore, in recent years, radio apparatuses that use this frequency band have been actively developed in a wireless LAN (Local Area Network) (IEEE (The Institute of Electrical and Electronics Engineers)) 802.11b/g/n), Bluetooth (registered trademark), a cordless telephone, and the like.

In a radio apparatus employing IEEE802.11b/g/n (hereinafter referred to as WLAN (Wireless LAN) apparatus), Direct Spread Spectrum (DSSS) and OFDM (Orthogonal Frequency Division Multiplexing) techniques are introduced taking into account anti-noise properties (see, for example, Non-Patent Literature 1 described below). Such a WLAN apparatus performs communication fixedly using one of fourteen channels specified in an ISM band of the 2.4 GHz band (one channel has an occupied frequency bandwidth corresponding to about twenty channels of a Bluetooth (registered trademark) apparatus.

In the WLAN apparatus, a CSMA/CA (Carrier Sense Multiple Access with Collision Avoidance) system is mainly introduced as a radio access system taking into account interoperability with other networks or other systems. In the CSMA/CA system, each WALN apparatus carrier-senses a radio channel prior to radio packet transmission. When it is confirmed by the carrier sense that the channel is in use (channel busy), the WLAN apparatus stands by for transmission of a radio packet and transmit the radio packet after a channel nonuse (channel idle) time and a back-off time which are determined in advance for each frame type.

On the other hand, in a radio communication apparatus complied with Bluetooth (registered trademark) (hereinafter referred to as BT apparatus), a Frequency Hopping Spread Spectrum (FHSS) technique is introduced likewise taking into account anti-noise properties (see, for example, Non-Patent Literature 2 described below). Specifically, the BT apparatus adopts a frequency hopping system for selecting one frequency channel (hereinafter referred to as FH channel) among 79 frequency channels having 1 MHz width set in a frequency band of 2.40 GHz to 2.48 GHz and switching, as time elapses, an FH channel to be selected so as to perform radio communication. In the frequency hopping system, selection of an FH channel is performed at every fixed time interval (e.g., 625 microseconds) based on a pseudo random algorithm determined in advance and allocates one-packet data to the selected FH channel to perform communication.

As explained above, both of the BT apparatus and the WLAN apparatus use the 2.4 GHz band. Therefore, if the BT apparatus and the WLAN apparatus are present in communication areas thereof common to each other, then radio waves transmitted by the BT apparatus and the WLAN apparatus interfere with each other thereby to jam communications of the apparatuses. As a method of avoiding such radio wave interference, there is a technique called Adaptive Frequency Hopping (AFH). In this technique, the BT apparatus measures a bit error rate (BER), a packet error rate (PER) or the like during transmission or measures a received signal intensity in a slot that is not involved in communication among BT apparatuses to thereby observe the quality of the FH channel on the BT apparatus side (susceptibility to a failure from other systems such as the WLAN apparatuses). The BT apparatus determines, based on a result obtained by the observation, an FH channel for which a radio wave that jams communication of the BT apparatus is present, and performs frequency hopping with avoiding the determined FH channel, thereby to prevent interference from the other system such as the WLAN.

### CITATION LIST

### Non-Patent Literature

Non-Patent Literature 1: IEEE, “IEEE Std IEEE802.11-2007”, 12 Jun. 2007
Non Patent Literature 2: Bluetooth (registered trademark), “Specification of Bluetooth System Covered Core Package Version: 3.0+HS”, 21 Apr. 2009

### SUMMARY

### Technical Problem

However, with the conventional AFH technique, interference from the other systems can be prevented on the BT apparatus side, but a method of preventing interference is not indicated concerning an apparatus on a side interfered by the BT apparatus. In particular, there is a problem in that the WLAN apparatus adopting the CSMA/CA system is deprived of transmission opportunities by a radio wave outputted by the BT apparatus and throughput performance is deteriorated.

There is a technique in which a radio apparatus mounted with the functions of both of the WLAN apparatus and the BT apparatus and configured to perform both of WLAN communication and BT communication puts transmission of one communication (the WLAN communication or the BT communication) on standby and suppresses interference of the WLAN communication and the BT communication according to a priority of a packet, which is called PTA (Packet Traffic Arbitration). However, even in this technique, because the transmission of either one of the WLAN communication and the BT communication is put on standby, there is a problem in that the throughput on the side put on standby is deteriorated and a propagation delay time increases accordingly.

The present invention has been devised in view of the above-mentioned circumstances, and it is an object of the present invention to obtain a radio communication apparatus and a radio communication method that can reduce interference with other communication.

### Solution to Problem

In order to solve the above-mentioned problems and achieve the object, the present invention provides a radio communication apparatus comprising: a frequency-hopping communication unit configured to perform frequency hopping communication, which is communication using frequency hopping; an other communication unit configured to perform communication in an other communication system, which is a communication system different from a communication system of the frequency-hopping communication unit; and

an information managing unit configured to acquire an other communication frequency band, which is a frequency band used for communication of the other communication unit, from the other communication unit, determine, based on the other communication frequency band, an unusable frequency band at the time of connection, and notify the other communication unit of the unusable frequency band, wherein the frequency hopping unit performs the frequency hopping using a frequency band excluding the unusable frequency band.

### Advantageous Effects of Invention

In the radio communication apparatus and the radio communication method according to the present invention, the information managing unit acquires communication information such as a channel used by the other communication unit, a priority of the communication, a quality of the communication or the like from the frequency hopping communication unit and the other communication unit and stores the communication information and determines an unusable channel based on the communication information, and the frequency hopping communication unit updates an AFH channel map based on the unusable channel. Therefore, there is an advantageous effect that it is possible to reduce interference with the other communication.

### BRIEF DESCRIPTION OF DRAWINGS

FIG. 1 is a diagram showing a configuration example of a radio communication system including a radio communication apparatus according to the present invention.

FIG. 2 is a diagram showing a functional configuration example of the radio communication apparatus.

FIG. 3 is a diagram showing another configuration example of the radio communication apparatus.

FIG. 4 is a sequence chart showing one example of an interference avoiding method.

FIG. 5 is an illustration showing a configuration example of a channel map for avoidance.

FIG. 6 is a flowchart showing one example of a procedure for generating a channel map for avoidance.

FIG. 7 is an illustration showing one example of an AFH channel map, a channel map for avoidance, and an after-AND channel map.

FIG. 8 is a chart showing a concept of a WLAN transmission stop time.

FIG. 9 is a chart showing a concept of a method in which a BT apparatus part gives up transmission of an unusable channel.

FIG. 10 is a sequence chart showing one example of an interference avoiding method in starting BT communication after starting WLAN communication.

### DESCRIPTION OF EMBODIMENTS

An embodiment of a radio communication apparatus and a radio communication method according to the present invention are described in detail below with reference to the drawings. The present invention is not limited by the embodiment.

### Embodiment

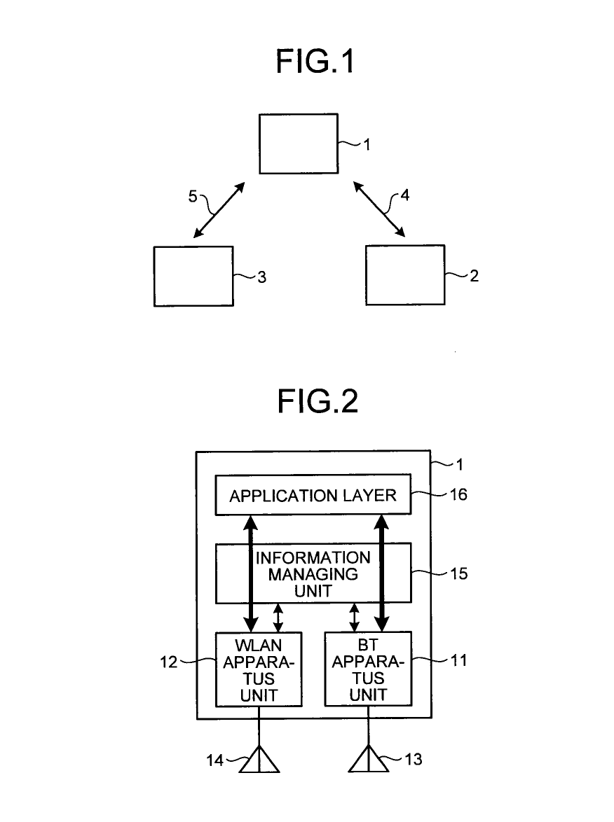

FIG. 1 is a diagram showing a configuration example of a radio communication system including a radio communication apparatus according to the present invention. As shown in FIG. 1, the radio communication system includes a radio communication apparatus 1, a BT (Bluetooth (registered trademark)) terminal 2 that performs Bluetooth (registered trademark) communication, and a WLAN terminal 3 that performs WLAN communication.

FIG. 2 is a diagram showing a functional configuration example of the radio communication apparatus 1. The radio communication apparatus 1 includes a BT apparatus unit 11 that performs BT communication, a WLAN apparatus unit 12 that performs WLAN communication, an antenna 13 that transmits and receives a radio signal of the BT communication, an antenna 14 that transmits and receives a radio signal of the WLAN communication, an information managing unit 15, and an application layer 16.

The radio communication apparatus 1 includes, as shown in FIG. 2, the BT apparatus unit 11 that performs the BT communication and the WLAN apparatus unit 12 that performs the WLAN communication. As shown in FIG. 1, the radio communication apparatus 1 performs BT communication 4 with the BT terminal 2 and performs WLAN communication 5 with the WLAN terminal 3. It is assumed that an AFH function is implemented in the BT terminal 2 and the BT apparatus unit 11 of the radio communication apparatus 1.

The information managing unit 15 of the radio communication apparatus 1 collects information on the BT communication and the WLAN communication from the BT apparatus unit 11 and the WLAN apparatus unit 12 as communication information and manages the communication information. The communication information includes, for example, information on connection (a device address of a communication counterpart), a frequency use status, a priority of communication, and the like. A method for the information managing unit 15 to collect the information may be a method for the BT apparatus unit 11 and the WLAN apparatus unit 12 when an event occurs to automatically notify the information managing unit 15 of information generated or acquired in the event as the communication information, or may be a method for the information managing unit 15 to regularly notifies the BT apparatus unit 11 and the WLAN apparatus unit 12 of an instruction for requesting collection of communication information. These two methods may be properly used depending upon the information. The application layer 16 performs predetermined application processing, applies predetermined transmission processing to transmission data, transmits the transmission data to a communication counterpart through the BT apparatus unit 11 or the WLAN apparatus 12, and applies predetermined reception processing to reception data received from the communication counterpart through the BT apparatus unit 11 or the WLAN apparatus 12.

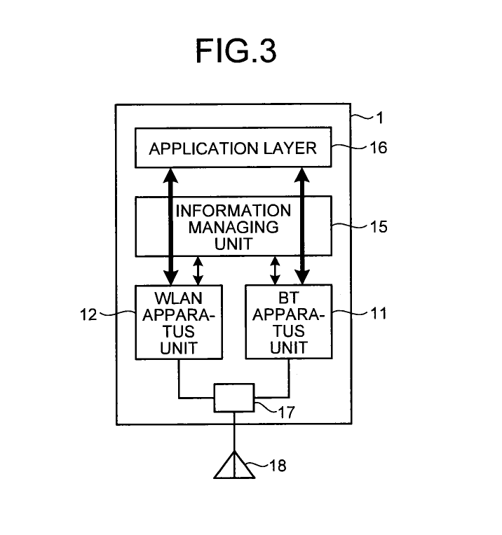

FIG. 3 is a diagram showing another configuration example of the radio communication apparatus 1. In the configuration example shown in FIG. 2, the BT apparatus unit 11 and the WLAN apparatus unit 12 respectively use different antennas (the antennas 13 and 14). However, in the example shown in FIG. 3, the BT apparatus unit 11 and the WLAN apparatus unit 12 share an antenna 18 instead of using the antennas 13 and 14. The radio communication apparatus 1 includes a coupler 17 that distributes a radio signal received from the antenna 18 to the BT apparatus unit 11 and the WLAN apparatus unit 12 in a manner that invasion of the signal is prevented from occurring. In the configuration example shown in FIG. 3, the operations of the BT apparatus unit 11, the WLAN apparatus unit 12, the information managing unit 15 and the application layer 16 are the same as those in the configuration example shown in FIG. 2.

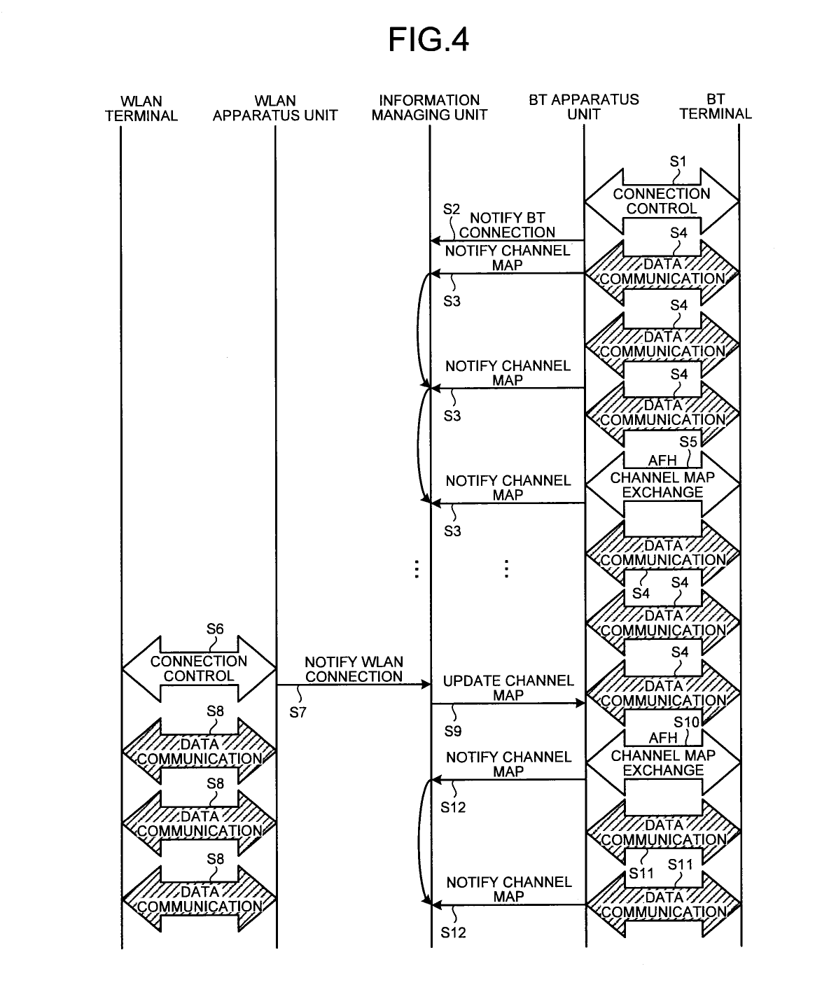

Next, an interference avoiding method according to this embodiment is explained. FIG. 4 is a sequence chart showing one example of the interference avoiding method according to this embodiment. In FIG. 4, a sequence chart is shown in which, based on the configuration shown in FIG. 1, after the BT terminal 2 is connected to the radio communication apparatus 1, the WLAN terminal 3 is connected to the radio communication apparatus 1.

First, the BT apparatus unit 11 of the radio communication apparatus 1 performs connection control processing for BT communication with the BT terminal 2 (step S1). The connection control processing for the BT communication is the same as that in the conventional. After completing the connection control processing, the BT apparatus unit 11 stores a device address of the BT terminal 2 obtained by the connection control processing in BT connection notification for notifying that the BT connection is completed, and notifies the information managing unit 15 of the device address (step S2).

The information managing unit 15 stores the after-notified device address as a part of communication information and increments the number of BT connections managed by the information managing unit 15. The information managing unit 15 manages the number of connections of the BT communications as the number of BT connections, sets an initial value of the number of BT connections to zero, and increments the number of BT connections when the BT connection notification is received. When connection ends, the information managing unit 15 decrements the number of BT connections.

On the other hand, after completion of the connection control processing, data communication by the BT communication is performed between the BT apparatus unit 11 of the radio communication apparatus 1 and the BT terminal 2 (step S4). The BT apparatus unit 11 carries out BT communication by AFH, updates, according to necessity, a channel map (an AFH channel map) used for selecting a channel used for frequency hopping in the AFH, and notifies the information managing unit 15 of the updated channel map. Thereafter, the information managing unit 15 regularly requests the BT apparatus unit 11 to make notification of the AFH channel map, and accordingly the BT apparatus unit 11 notifies the information managing unit 15 of the AFH channel map (step S3). The AFH channel map is a map indicating, for each FH channel usable in the BT communication, whether the BT apparatus unit 11 can be used for the BT communication. As with the conventional BT terminal, the BT apparatus unit 11 observes reception quality for each FH channel, and determines, based on a result of the observation, whether or not the FH channel is a usable channel.

During the data communication with the BT terminal 2, the information managing unit 15 receives notification from the BT apparatus unit 11, receives notification from the application layer 16, or snoops communication data exchanged between the application layer 16 and the BT apparatus unit 11 to thereby detect a type of a protocol such as ACL (Asynchronous Connection Less) or SCO (Synchronous Connection Oriented) and determine a priority of the BT communication (whether the priority of the BT communication is set high or low with respect to the WLAN communication) based on the type of the protocol and the like. In this embodiment, the priority of the BT communication is determined based on the type of the protocol. However, this is not a limitation. The priority of the BT communication can be determined based on other parameters or in a manner that it is set in advance.

While performing the data communication with the BT terminal 2, the BT apparatus unit 11 observes reception quality according to necessity and exchanges, based on the observation result, the AFH channel map with the BT terminal 2 (step S5). At the step S3 mentioned above, the information managing unit 15 regularly requests the BT apparatus unit 11 to notify the AFH channel map. Alternatively, when the BT apparatus unit 11 updates the AFH channel map, the BT apparatus unit 11 may autonomously notify the information managing unit 15 of the updated AFH channel map.

It is assumed that the radio communication apparatus 1 starts communication with the WLAN terminal 3 in a state of communication with the BT terminal 2 as explained above. The WLAN apparatus unit 12 performs connection control processing for the WLAN communication with the WLAN apparatus 3 (step S6). The WLAN apparatus unit 12 stores a channel to be used for the WLAN communication and a device address of the connected WLAN terminal 3 in WLAN connection notification for notifying that the WLAN communication has been started and notifies the information managing unit 15 of the channel and the device address (step S7). Timing for issuing the WLAN connection notification may be, for example, timing when the WLAN apparatus unit 12 has determined a channel to be used using Scan or the like, timing when the WLAN apparatus unit 12 transmits or receives a connection frame of WLAN such as Probe, Authentication or Association, or timing when 4-way-handshake has started or ended. The WLAN apparatus unit 12 only has to issue the WLAN connection notification any one of the timings.

When the information managing unit 15 receives the WLAN connection notification, the information managing unit 15 stores the notified device address as a part of the communication information, and increments the number of WLAN connections managed by the information managing unit 15. The information managing unit 15 manages the number of connections of WLAN communications as the number of WLAN connections, sets an initial value of the number of WLAN connections to zero, and increments the number of WLAN connections when the WLAN connection notification is present. When connection ends, the information managing unit 15 decrements the number of WLAN connections.

The WLAN apparatus unit 12 performs data communication by the WLAN communication with the WLAN terminal 3 (step S8). The information managing unit 15 generates, based on the channel used for the WLAN communication notified by the WLAN connection notification, a channel map for avoidance used for performing frequency hopping avoiding an FH channel that may be interference with the WLAN terminal 3, and notifies the BT apparatus unit 11 of the generated channel map (step S9).

The BT apparatus unit 11 updates the AFH channel map based on the notified channel map for avoidance and the AFH channel map at that point, and carries out exchange of the AFH channel map with the BT terminal 2 (step S10). The BT apparatus unit 11 performs data communication by frequency hopping based on the updated channel map (step S11). The BT apparatus unit 11 regularly issues notification of the AFH channel map (step S12).

Thereafter, the information managing unit 15 generates a channel for avoidance again based on the stored communication information (the priority of the BT communication, the AFH channel map, etc.) when the reception quality of the BT communication has changed (the AFH channel has been changed) or when the priority of the BT communication has changed, and notifies the BT apparatus unit 11 of the generated channel for avoidance. Then, the BT apparatus unit 11 updates the AFH channel based on the AFH channel map and the channel for avoidance.

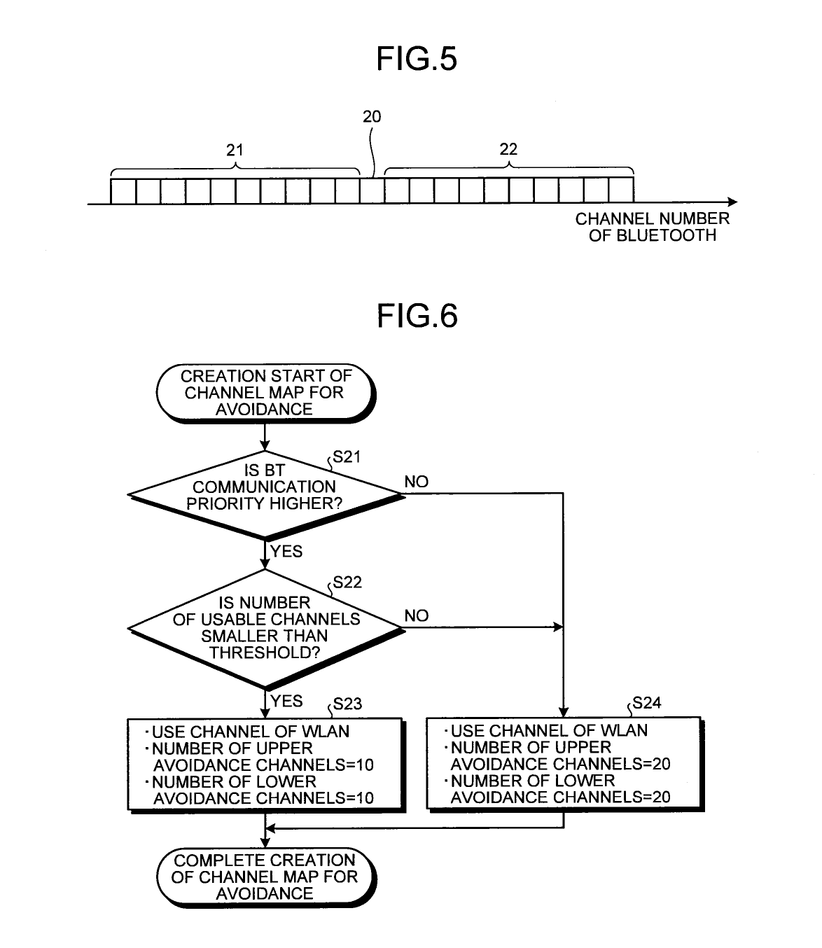

FIG. 5 is an illustration showing a configuration example of the channel map for avoidance in this embodiment. The channel map for avoidance includes three parameters, that is, a “WLAN use channel”, a “high-order avoidance channel” and a “low-order avoidance channel”. In FIG. 5, a channel number (a number for an FH channel) of Bluetooth (registered trademark) is shown on the abscissa. As shown in FIG. 5, the channel map for avoidance is composed of a WLAN use channel 20, a high-order avoidance channel 22, which is FH channels for a predetermined number of avoidance channels that have upper positions (larger numbers and higher frequencies) than the WLAN use channel, and a low-order avoidance channel 21, which is FH channels for a predetermined number of avoidance channels that have lower positions (smaller numbers and lower frequencies) than the WLAN use channel.

FIG. 6 is a flowchart showing one example of a procedure for generating the channel map for avoidance. It is noted that FIG. 6 is one example, and the order and contents of processing are not limited to this example, but the procedure may be any method as long as the method is of generating a channel map for avoidance having the same contents.

First, the information managing unit 15 determines, based on the priority of the BT information of the stored communication information, whether or not the BT communication has a higher priority (step S21). If the information managing unit 15 determines that the BT communication has a higher priority (Yes at the step S21), then the information managing unit 15 determines, based on the AFH channel map, whether or not the number of channels usable for the BT communication is smaller than a predetermined threshold (step S22).

If the information managing unit 15 determines that the number of channels usable for the BT communication is smaller than the predetermined threshold (Yes at the step S22), then the information managing unit 15 determines that it is necessary to reduce the number of avoidance channels for avoiding interference with the WLAN communication, and sets the number of avoidance channels to 10 (step S23). The information managing unit 15 generates, based on the WLAN use channel and the number of avoidance channels, a channel map for avoidance (a channel map in which the WLAN use channel and ten channels higher in order and ten channels lower in order than the WLAN use channel are set as FH channels not in use (unusable channels)), and ends the processing.

If the information managing unit 15 determines at the step S21 that the BT communication does not have a higher priority (No at the step S21) and if the information managing unit 15 determines at the step S22 that the number of channels usable for the BT communication is equal to or larger than the predetermined threshold (No at the step S22), then the information managing unit 15 judges that it is necessary to increase the number of avoidance channels for avoiding interference with the WLAN communication, and sets the number of avoidance channels to 20 (step S24). Then, the information managing unit 15 generates, based on the WLAN use channel and the number of avoidance channels, a channel map for avoidance (a channel map in which the WLAN use channel and twenty channels higher in order and twenty channels lower in order than the WLAN use channel are set as unusable channels), and ends the processing.

The number of avoidance channels is set to 10 at the step S23 and set to 20 at the step S24. However, these numerical values are examples. As long as a larger numerical value is set at the step S24 than at the step S23, any value larger than zero may be set as the number of avoidance channels. The number of avoidance channels may be determined beforehand taking into account filter characteristics and the like of the apparatus or can be determined based on a measurement result obtained by measuring an interference amount using some sort of method. The number of high-order avoidance channels and the number of low-order avoidance channels may be set as different values.

In this embodiment, as an example, the number of avoidance channels is determined based on the priority of the BT communication, the number of channels usable for BT, and the like. Alternatively, the number of avoidance channels may be determined based on a traffic amount of the WLAN communication, a mode of the WLAN apparatus unit 12 such as an Awake mode (normal mode) or a Sleep mode (power saving mode), and the like as conditions for determining the number of avoidance channels. Further, the number of avoidance channels may be determined using any one or more of the priority of the BT communication, the number of channels usable for BT, the traffic amount of the WLAN communication, and the mode of the WLAN apparatus unit 12 explained above. For example, when the WLAN apparatus unit 12 is in the Sleep mode, the number of avoidance channels is set to a small number, and when the traffic amount of the WLAN communication is small, the number of avoidance channels is set to a small number.

The BT apparatus unit 11 makes AND of the channel map for avoidance received from the information managing unit 15 and the AFH channel map stored at that point (makes AND of the unusable channels), and sets a channel map as a result of the AND as a new AFH channel map.

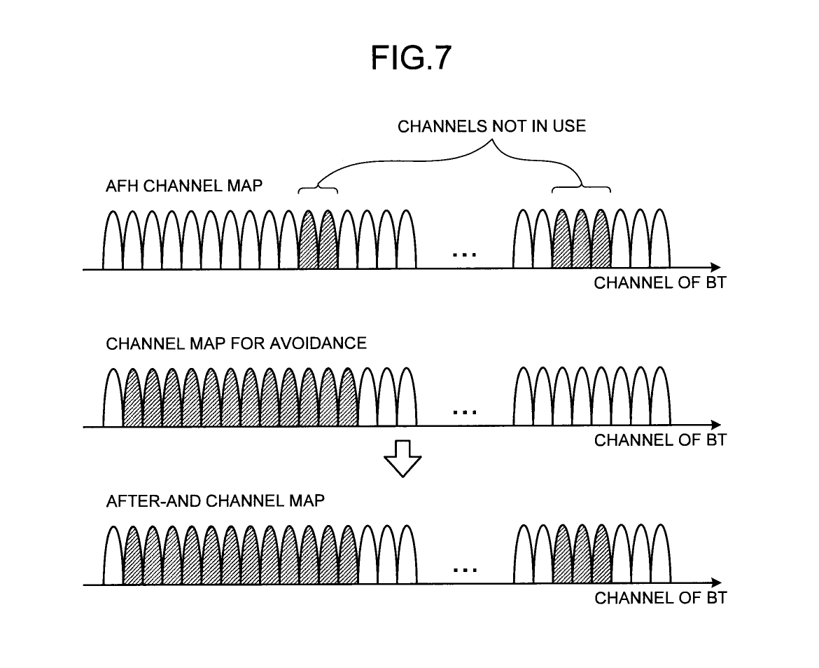

FIG. 7 is a diagram showing an example of an AFH channel map, a channel map for avoidance, and an after-AND channel map. The upper section shows an example of the AFH channel map before an AND operation. The middle section shows an example of the channel map for avoidance. The lower section shows an example of the channel map obtained by the AND operation of the two channel maps. In the figure, hatched channels indicate channels not in use (unusable channels) and white void channels indicate usable channels.

The BT apparatus unit 11 generates a channel map obtained by the AND operation in this way, and updates the AFH channel map with the generated channel map. Then, the BT apparatus unit 11 notifies the BT terminal 2, which is the communication counterpart as explained above, of the updated AFH channel map. As described above, it is possible to prevent the BT communication using the AFH channel map after the update from becoming an interference source for WLAN.

Until the AFH channel map is updated, the BT communication is likely to be an interference source for the WLAN communication. Therefore, waiting mode is held without performing the WLAN communication until the updated AFH channel map is notified to the BT terminal 2 (exchange of the AFH channel map) after WLAN connection control is completed.

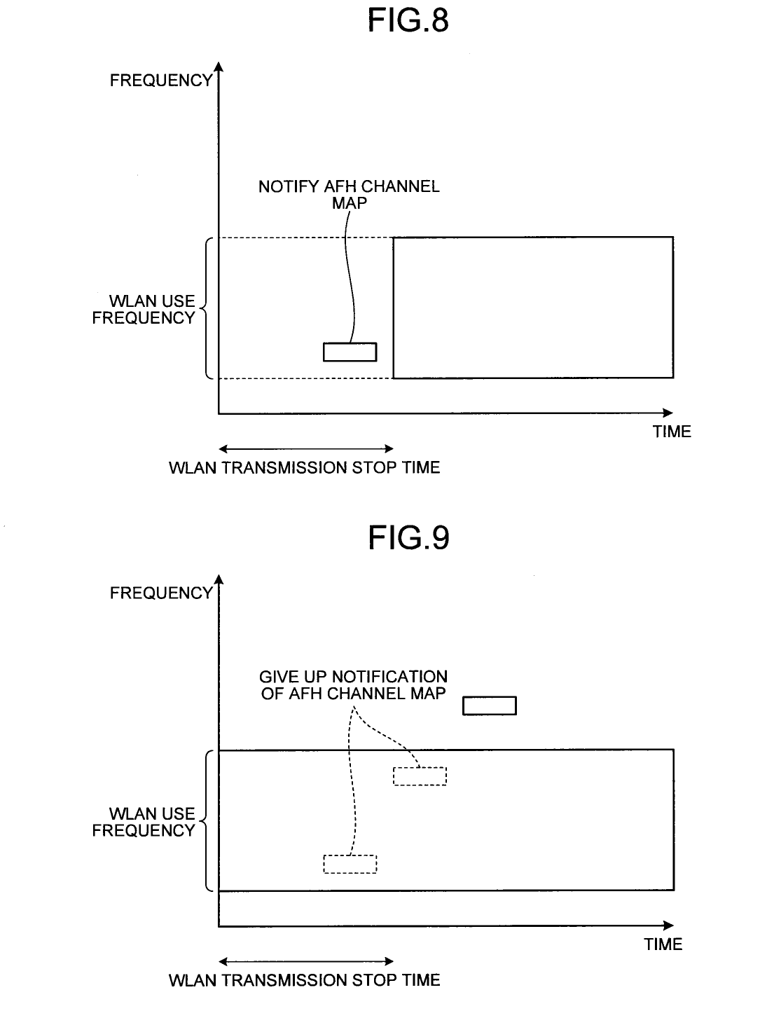

FIG. 8 is a chart showing a concept of WLAN transmission stop time. The information managing unit 15 instructs the WLAN apparatus unit 12 to stay on standby for the WLAN communication until the updated AFH channel map is notified to the BT terminal 2 (communication using the updated AFH channel map become possible) after the WLAN connection control is completed. After the updated AFH channel map is notified to the BT terminal 2 (communication using the updated AFH channel map becomes possible), the information managing unit 15 instructs the WLAN apparatus unit 12 to start the WLAN communication. When the updated AFH channel map is notified to the BT terminal 2 (the channel map is exchanged), the BT apparatus unit 11 notifies the information managing unit 15 of that effect or the BT apparatus unit 11 notifies the information managing unit 15 of the AFH channel map.

The method explained with reference to FIG. 8 above does not have to be used and a method in which the BT apparatus unit 11 gives up transmission of an unusable channel may be used. FIG. 9 is a chart showing a concept of the method in which the BT apparatus unit 11 gives up transmission of an unusable channel. When the BT apparatus unit 11 is scheduled to perform transmission using an unusable channel on the updated AFH channel map before exchange of the updated AFH channel map after the WLAN connection control is completed, the BT apparatus unit 11 gives up transmission relying on the transmission timing. Then, the BT apparatus unit 11 transmits, through frequency hopping, at transmission timing when a selected channel becomes a channel usable on the updated AFH channel map, data having been scheduled to be transmitted at the transmission timing when the transmission has been given up.

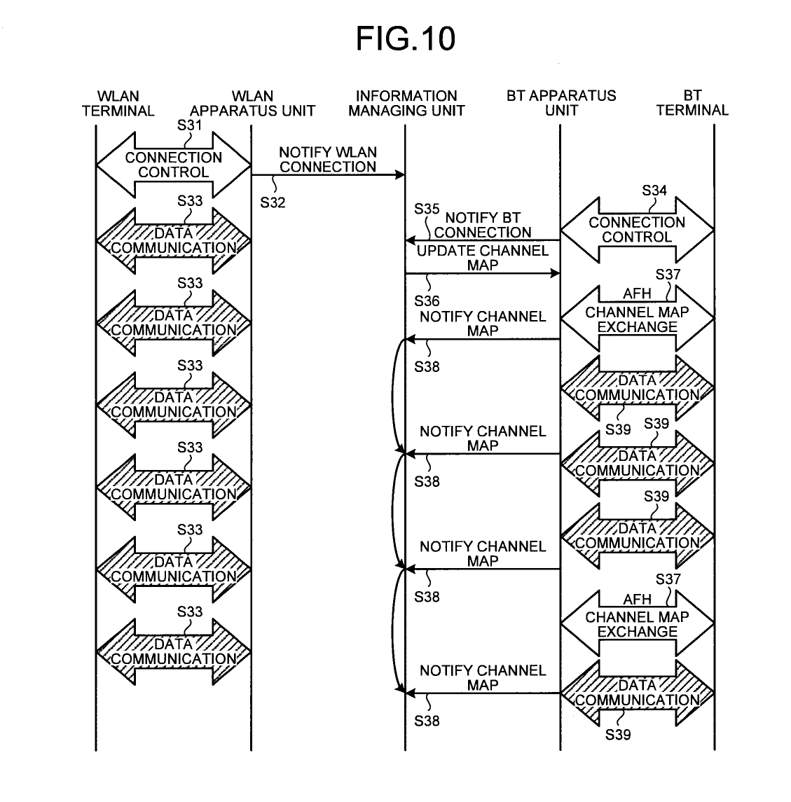

Operation for starting the BT communication after starting the WLAN communication is explained. FIG. 10 is a sequence chart showing one example of a method of avoiding interference in this embodiment in starting the BT communication after starting the WLAN communication.

As shown in FIG. 10, first, connection control processing for the WLAN communication is performed between the WLAN terminal 3 and the WLAN apparatus unit 12 (step S31). As with the step S7, the WLAN apparatus unit 12 stores a channel used for the WLAN communication and a device address of the connected WLAN terminal 3 in WLAN connection notification for notifying that the WLAN communication is started, and notifies the information managing unit 15 of the channel and the device address (step S32). When the information managing unit 15 receives the WLAN connection notification, the information managing unit 15 increments the number of WLAN connections. Data communication is performed between the WLAN terminal 3 and the WLAN apparatus unit 12 (step S33).

In that state, connection control processing for the BT communication is performed between the BT terminal 2 and the BT apparatus unit 11 (step S34). After the completion of the connection control processing, as with the step S2, the BT apparatus unit 11 stores a device address of the BT terminal 2 obtained by the connection control processing in BT connection notification for notifying that the BT connection is completed, and notifies the information managing unit 15 of the device address (step S35).

The information managing unit 15 increments the number of BT connections. The information managing unit 15 generates a channel map for avoidance based on the WLAN notification issued at the step S32 and based on the use channel of the WLAN communication. In this state, unlike the example explained with reference to FIG. 4 above, the information of the priority of the BT communication and the number of BT use channels (the number of channels usable in the BT communication) and the like are absent. Therefore, concerning the priority of the BT communication and the number of BT use channels, a channel map for avoidance is generated using values set in advance (default values). In this embodiment, as the default values, the priority of the BT communication is set to low priority, and the number of BT use channels is set to 79 (corresponding to usableness of all FH channels of the BT communication).

The information managing unit 15 generates a channel map for avoidance according to the procedure explained with reference to FIG. 5 and notifies the BT apparatus unit 11 of the channel map for avoidance (step S36). When the connection control processing at the step S34 is completed, the BT apparatus unit 11 generates an AFH channel map used in AFH for the BT communication. In generating the AFH channel map, when the channel for avoidance has been notified to the BT apparatus unit 11, the BT apparatus unit 11 generates an updated AFH channel map based on the generated AFH channel map and the channel for avoidance. The BT apparatus unit 11 exchanges the AFH channel map with the BT terminal 2 (step S37).

When the information managing unit 15 receives the BT connection notification by the step S35, the information managing unit 15 instructs the WLAN apparatus unit 12 to stay on standby for the WLAN communication to prevent the BT communication from interfering with the WLAN communication. After the exchange of the AFH channel map by the step S37, the information managing unit 15 instructs the WLAN apparatus unit 12 to start the WLAN communication. As explained with reference to FIG. 9, the method in which the BT apparatus unit 11 gives up the transmission of the unusable channel may be used.

As in the example explained with reference to FIG. 4, the BT apparatus unit 11 regularly issues notification of the AFH channel map (step S38). The BT apparatus unit 11 performs data communication with the BT terminal 2 (step S39).

As in the example explained with reference to FIG. 4, during the data communication with the BT terminal 2, the information managing unit 15 receives notification from the BT apparatus unit 11, receives notification from the application layer 16, or snoops communication data exchanged between the application layer 16 and the BT apparatus unit 11 to thereby detect a type of a protocol such as ACL or SCO and determine a priority of the BT communication based on the type of the protocol and the like.

The information managing unit 15 updates the channel for avoidance based on the determined priority of the BT communication and the AFH channel map notified from the BT apparatus unit 11, and notifies the BT apparatus unit 11 of the updated channel for avoidance. As in the example shown in FIG. 4, the BT apparatus unit 11 makes AND operation of the channel for avoidance and the AFH channel, and updates the AFH channel.

Thereafter, based on the stored communication information (the priority of the BT communication, the AFH channel map, etc.), the information managing unit 15 generates a channel for avoidance again when the reception quality of the BT communication changes (the AFH channel is changed) or when the priority of the BT communication changes, and notifies the BT apparatus unit 11 of the generated channel for avoidance. Then, the BT apparatus unit 11 updates the AFH channel based on the AFH channel map and the channel for avoidance.

In this embodiment, the number of high-order avoidance channels and the number of low-order avoidance channels are determined based on the priority of the BT communication. However, a fixed number of avoidance channels (no less than zero) may be used or the number of avoidance channels may be determined based on other conditions, without using the priority of the BT communication.

In this embodiment, as a communication system for performing communication avoiding interference with another communication, a BT communication system is explained as an example. However, the present invention is not limited to the BT communication. The present invention can also be applied to a communication system other than the BT communication system as long as the communication system carries out frequency hopping. In other words, the BT apparatus unit 11 is an example of a frequency-hopping communication means that perform communication through frequency hopping.

In this embodiment, as another communication, the WLAN communication is explained as an example. However, the present invention is not limited to the WLAN communication. The present invention can also be applied to the case where an other communication system using a frequency band same as that of the BT communication is performed simultaneously with the BT communication. In other words, the WLAN apparatus unit 12 is an example of other communication means that perform communication in a communication system other than the above-mentioned frequency-hopping communication means. In that case, the information managing unit 15 acquires, instead of the use channel of the WLAN communication, a frequency band used in the other communication system, and generates a channel map for avoidance in which the frequency band used in the other communication system and high-order and low-order channels of the frequency band are set as unusable channels. The present invention can also be applied likewise to the case where a plurality of other communication systems are provided for the other communication system instead of one communication system. In this case, frequency bands in use respectively from the other communication systems are acquired, and a channel map for avoidance in which the frequency bands and high-order and low-order channels of the frequency bands are set as unusable channels is generated.

As described above, in this embodiment, the information managing unit 15 acquires the communication information from the BT apparatus unit 11 and the WLAN apparatus unit 12 and stores the communication information, and generates the channel map for avoidance based on the use channel of the WLAN communication, the priority of the communication, the quality of the communication, and the like. Besides, the BT apparatus unit 11 updates the AFH channel map based on the channel map for avoidance. Therefore, it is possible to perform the BT communication with reducing interference with the other communication.

### INDUSTRIAL APPLICABILITY

As above, the radio communication apparatus and the radio communication method according to the present invention are useful for a radio communication apparatus that performs communication in a plurality of communication systems and, in particular, suitable for a radio communication apparatus including the BT communication system as a communication system.

### REFERENCE SIGNS LIST

1 RADIO COMMUNICATION APPARATUS
2 BT TERMINAL
3 WLAN TERMINAL
4 BT COMMUNICATION
5 WLAN COMMUNICATION
11 BT APPARATUS UNIT
12 WLAN APPARATUS UNIT
13, 14, 18 ANTENNAS
15 INFORMATION MANAGING UNIT
16 APPLICATION LAYER
17 COUPLER
20 WLAN USE CHANNEL
21 LOW-ORDER AVOIDANCE CHANNEL
22 HIGH-ORDER AVOIDANCE CHANNEL

1. A radio communication apparatus comprising:
a frequency-hopping communication unit configured to perform frequency hopping communication, which is communication using frequency hopping;
an other communication unit configured to perform communication in an other communication system, which is a communication system different from a communication system of the frequency-hopping communication unit; and
an information managing unit configured to acquire an other communication frequency band, which is a frequency band used for communication of the other communication unit, from the other communication unit, determine, based on the other communication frequency band, an unusable frequency band at the time of connection, at the time of disconnection, or at the time when radio communication quality changes, and notify the frequency-hopping communication unit of the unusable frequency band,
wherein the frequency-hopping communication unit performs the frequency hopping using a frequency band excluding the unusable frequency band.

2. The radio communication apparatus according to claim 1, wherein the unusable frequency band is determined as a frequency band from a frequency lower than the other communication frequency band by a predetermined low-order frequency to a frequency higher than the other communication frequency band by a predetermined high-order frequency.

3. The radio communication apparatus according to claim 2, wherein the information managing unit determines the unusable frequency band further based on a priority of the frequency hopping communication.

4. The radio communication apparatus according to claim 2, wherein the information managing unit determines the unusable frequency band further based on a frequency band usable in the frequency hopping communication.

5. The radio communication apparatus according to claim 3, wherein the information managing unit determines the unusable frequency band further based on a frequency band usable in the frequency hopping communication.

6. The radio communication apparatus according to claim 2, wherein the information managing unit determines the unusable frequency band further based on one or more of the traffic amount of the other system communication and whether or not the other system communication is in a power saving state.

7. The radio communication apparatus according to claim 3, wherein the information managing unit determines the unusable frequency band further based on one or more of the traffic amount of the other system communication and whether or not the other system communication is in a power saving state.

8. The radio communication apparatus according to claim 4, wherein the information managing unit determines the unusable frequency band further based on one or more of the traffic amount of the other system communication and whether or not the other system communication is in a power saving state.

9. The radio communication apparatus according to claim 5, wherein the information managing unit determines the unusable frequency band further based on one or more of the traffic amount of the other system communication and whether or not the other system communication is in a power saving state.

10. The radio communication apparatus according to claim 2, wherein the low-order frequency and the high-order frequency are determined independently from each other.

11. The radio communication apparatus according to claim 1, wherein the information managing unit instructs the other communication unit to stop the other communication until the frequency-hopping communication unit notifies a communication counterpart for the frequency hopping communication of the frequency band excluding the unusable frequency band as a frequency band used in the frequency hopping communication, and instructs the other communication unit to awake the stop of the other communication after the frequency-hopping communication unit notifies the communication counterpart of the frequency band excluding the unusable frequency band as the frequency band used in the frequency hopping communication.

12. The radio communication apparatus according to claim 10, wherein the information managing unit instructs the other communication unit to stop the other communication until the frequency-hopping communication unit notifies a communication counterpart for the frequency hopping communication of the frequency band excluding the unusable frequency band as a frequency band used in the frequency hopping communication, and instructs the other communication unit to awake the stop of the other communication after the frequency-hopping communication unit notifies the communication counterpart of the frequency band excluding the unusable frequency band as the frequency band used in the frequency hopping communication.

13. The radio communication apparatus according to claim 1, wherein
the information managing unit instructs the frequency-hopping communication unit to avoid transmission scheduled to use a frequency within the unusable frequency band until the frequency-hopping communication unit notifies a communication counterpart for the frequency hopping communication of the frequency band excluding the unusable frequency band as a frequency band used in the frequency hopping communication, and
the frequency-hopping communication unit gives up, based on the instruction from the information managing unit, transmission at timing when the transmission at the frequency within the unusable frequency band is scheduled, and transmits transmission data, which is scheduled to be transmitted at the timing, at timing of transmission performed using a frequency outside the unusable frequency band.

14. The radio communication apparatus according to claim 10, wherein
the information managing unit instructs the frequency-hopping communication unit to avoid transmission scheduled to use a frequency within the unusable frequency band until the frequency-hopping communication unit notifies a communication counterpart for the frequency hopping communication of the frequency band excluding the unusable frequency band as a frequency band used in the frequency hopping communication, and
the frequency-hopping communication unit gives up, based on the instruction from the information managing unit, transmission at timing when the transmission at the frequency within the unusable frequency band is scheduled, and transmits transmission data, which is scheduled to be transmitted at the timing, at timing of transmission performed using a frequency outside the unusable frequency band.

15. The radio communication apparatus according to claim 1, wherein the frequency hopping communication is Bluetooth (registered trademark) communication, and the other communication is WLAN communication.

16. The radio communication apparatus according to claim 11, wherein the frequency hopping communication is Bluetooth (registered trademark) communication, and the other communication is WLAN communication.

17. A radio communication method comprising:
a frequency-hopping communication step for performing frequency hopping communication, which is communication performed using frequency hopping;
an other communication step for performing communication in an other communication system, which is a communication system different from a communication system of the frequency-hopping communication step;
an information managing step for acquiring an other communication frequency band, which is a frequency band used for communication in the other communication system, and determining, based on the other communication frequency band, an unusable frequency band; and
an interference avoiding step for performing the frequency hopping communication using a frequency band excluding the unusable frequency band.

18. The radio communication apparatus according to claim 13, wherein the frequency hopping communication is Bluetooth (registered trademark) communication, and the other communication is WLAN communication.
